(19) United States
(12) Patent Application Publication
(10) Pub. No.: US 2011/0168487 A1
(43) Pub. Date: Jul. 14, 2011

(54) Strap Management Apparatus and Arrangement

(76) Inventors: Jeremy A. Steck, Pittsburgh, PA (US); Grant M. Myers, Pittsburgh, PA (US); Lucas O. Nene, Erie, PA (US)

(21) Appl. No.: 13/005,142

(22) Filed: Jan. 12, 2011

Related U.S. Application Data
(60) Provisional application No. 61/294,642, filed on Jan. 13, 2010.

(51) Int. Cl. A62B 35/00; F16G 11/00; F16G 11/10

(52) U.S. Cl. 182/3; 24/115 R; 24/115 G

(57) ABSTRACT

A strap management apparatus for an attachable arrangement including at least one elongate strap having at least one free end. The strap management apparatus includes: a substantially rigid member having a body with a first end and a second end; and at least one substantially elastic member operatively engaging the body of the rigid member and a portion of the at least one strap of the attachable arrangement; wherein the rigid member is configured to be urged away from the portion of the at least one strap, thereby creating a generally rectangular or trapezoidal opening through which the at least one free end of the at least one strap can be inserted. An attachable arrangement is also disclosed.

### CROSS REFERENCE TO RELATED APPLICATIONS

This application claims benefit of priority from U.S. Provisional Patent Application No. 61/294,642, filed Jan. 13, 2010, which is incorporated herein by reference in its entirety.

### BACKGROUND OF THE INVENTION

1. Field of the Invention

The present invention relates generally to attachable arrangements, e.g., harnesses, belts, fall protection arrangements, and the like, and in particular to a strap management apparatus and arrangement for use in connection with such attachable arrangements.

2. Description of the Related Art

As is known in the art, there exist various embodiments and arrangements that are attachable to a person to provide assistance to the wearer or ensure the wearer's safety in certain situations. Such attachable arrangements come in many forms, including, but not limited to, harnesses, safety belts, climbing harnesses, fall protection harnesses, safety harnesses, and fall protection arrangements. While there are many variations in such attachable arrangements, all normally include one or more elongate straps that are adjustable to fit different wearers. In operation, a person will don the attachable arrangement, attach the straps around the specified parts of his or her body, and adjust these straps to fit comfortably, yet effectively.

For example, full body harnesses are widely used for lifting and lowering individuals in dangerous situations and as a primary component in a personal fall arrest system. These harnesses can also be used for work positioning, travel restriction, ladder climbing, rescue retrieval, and evacuation. While these harnesses are used mainly in an industrial setting, and particularly the construction industry where the likelihood and danger of falls from heights is both numerous and significant, a full body harness can be used in various other applications in which total suspension and support of the body must be ensured, either expectedly or unexpectedly. Various harnesses are illustrated in U.S. Pat. Nos. 6,804,830; 5,957,091; and 4,712,513, all of which are incorporated herein by reference.

One common drawback associated with many of these existing strap-based attachable arrangements is the existence of the loose or free ends of the straps after adjustment thereof. These free ends potentially pose a safety risk in situations that require the use of an attachable arrangement. In a fall protection environment, loose or free ends may get caught or tangled, which could result in a variety of unsafe and dangerous conditions. Therefore, there is a need to hold or attach these free strap ends to keep them from dangling loosely from the attachable arrangement.

According to the prior art, in many instances, the wearer will tuck the free ends of the straps into his or her pockets, or alternatively wrap or knot these ends around the tightened straps on the remaining portions of the attachable arrangement. However, tucking or tying these straps is not ideal, as more often than not, these straps will become loose again while the wearer is engaged in various activities.

In an attempt to address these situations, manufacturers have arrived at various strap attachment arrangements and devices. For example, on harnesses that include side D-rings, a slot may be provided on the sides for tucking the free ends of the leg straps. However, these D-rings are not adjustable, nor are they flexible, such that dislodgement remains an issue. Further, many attachable arrangements do not include these D-rings. As another example, a hook can be attached to the end of the strap, and this hook is engaged with a side of a tightened strap. However, this hook may easily be disengaged in use, which results in excess strap material dangling in and around the user's body.

As another example, certain attachable arrangements include flexible bands or loops attached around one or more of the straps, and the user must manipulate the band or loop and insert the free end of the strap. However, manipulating the band or loop is quite difficult in the field, especially given that the user is usually wearing work gloves. In order to permit easier manipulation, some manufacturers provide a tab attached to the band or loop. However, in practice this tab still proves difficult for the user to grasp and manipulate the band or loop. Further, when using such a tab, and in operation, the resultant opening through which the free end of the strap can be inserted is triangular or some other shape that makes it difficult to quickly and effectively insert the free end of the strap, often leading to the wearer “giving up” and using one of the above ineffective, but easily implemented, methods.

Accordingly, there remains a need in the art of attachment arrangements, such as belts, harnesses, safety equipment, and the like for an improved strap management system and arrangement. In particular, there remains a need for a strap management apparatus and arrangement that is equally useful in connection with new and existing attachable arrangements, where the strap management apparatus is easy to adjust and manipulate for insertion of the free end of a strap. Such ease of manipulation (particularly in the field and during use) decreases any likelihood of catching the loose end of a strap on objects in the environment, which may result in a dangerous situation.

### SUMMARY OF THE INVENTION

Generally, the present invention provides a strap management apparatus and arrangement that overcomes some or all of the drawbacks and deficiencies existing in the prior art and provides a strap management apparatus and arrangement that is useful in connection with new and existing attachable arrangements, e.g., harnesses, belts, and the like. Preferably, the present invention provides a strap management apparatus and arrangement that can be adjusted by the user along the length of a strap of an attachable arrangement. Preferably, the present invention provides a strap management apparatus and arrangement that is easy to manipulate in the field and during use of the attachable arrangement. Preferably, the present invention provides a strap management apparatus and arrangement that, in operation, allows for the easy insertion of the free end of a strap of an attachable arrangement.

In a preferred and non-limiting embodiment, the present invention provides a strap management apparatus for an attachable arrangement including at least one elongate strap having at least one free end. The strap management apparatus includes a substantially rigid member having a body with a first end and a second end, and at least one substantially elastic member operatively engaging the body of the rigid member and a portion of at least one strap of the attachable arrangement. The rigid member is configured to be urged away from the portion of the at least one strap, thereby creating an opening through which the at least one free end of at least one strap can be inserted.

In another preferred and non-limiting embodiment, the present invention provides an attachable arrangement, including at least one elongate strap having at least one free end, and at least one strap management apparatus. The strap management apparatus includes: (i) a substantially rigid member having a body with a first end and a second end; and (ii) at least one substantially elastic member operatively engaging the body of the rigid member and a portion of at least one strap of the attachable arrangement. The rigid member is configured to be urged away from the portion of at least one strap, thereby creating an opening through which at least one free end of at least one strap can be inserted.

In a still further preferred and non-limiting embodiment, the present invention provides an attachable arrangement for removable attachment to a person. The attachable arrangement includes a plurality of elongate attachment straps, and at least one of the plurality of attachment straps includes at least one free end. Further, the attachable arrangement includes at least one strap management apparatus, including: (i) a substantially rigid member having a body with a first end and a second end; and (ii) at least one substantially elastic member operatively engaging the body of the rigid member and a portion of at least one of the plurality of straps of the attachable arrangement. The rigid member is configured to be urged away from the portion of at least one of the plurality of straps, thereby creating an opening through which the at least one free end of at least one of the plurality of straps can be inserted.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of one embodiment of a strap management apparatus, in use, according to the principles of the present invention;

FIG. 2 is a schematic view of the strap management apparatus of FIG. 1 in use;

FIG. 3 is a side view of another embodiment of a strap management apparatus according to the principles of the present invention;

FIG. 4 is a perspective view of the strap management apparatus of FIG. 3 in use;

FIG. 5 is a top perspective view of a portion of a further embodiment of a strap management apparatus according to the principles of the present invention;

FIG. 6 is a bottom perspective view of the portion of the strap management apparatus of FIG. 5;

FIG. 7 is a top view of the portion of the strap management apparatus of FIG. 5;

FIG. 8 is a bottom view of the portion of the strap management apparatus of FIG. 5;

FIG. 9 is a side view of the portion of the strap management apparatus of FIG. 5;

FIG. 10 is an edge view of the portion of the strap management apparatus of FIG. 5;

FIG. 11 is a perspective view of a further embodiment of a strap management apparatus according to the principles of the present invention, as attached to a strap of an attachable arrangement;

FIG. 12 is a perspective view of the strap management apparatus of FIG. 11 in use;

FIG. 13 is a perspective view of another embodiment of a strap management apparatus, in use, according to the principles of the present invention;

FIG. 14 is a side view of a still further embodiment of a strap management apparatus, in use, according to the principles of the present invention;

FIG. 15 is a top view of another embodiment of a strap management apparatus according to the principles of the present invention;

FIG. 16 is a side view of a further embodiment of a strap management apparatus, in use, according to the principles of the present invention; and

FIG. 17 is a front view of a full body harness according to the prior art, with an embodiment of a strap management apparatus according to the principles of the present invention, attached to several straps.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

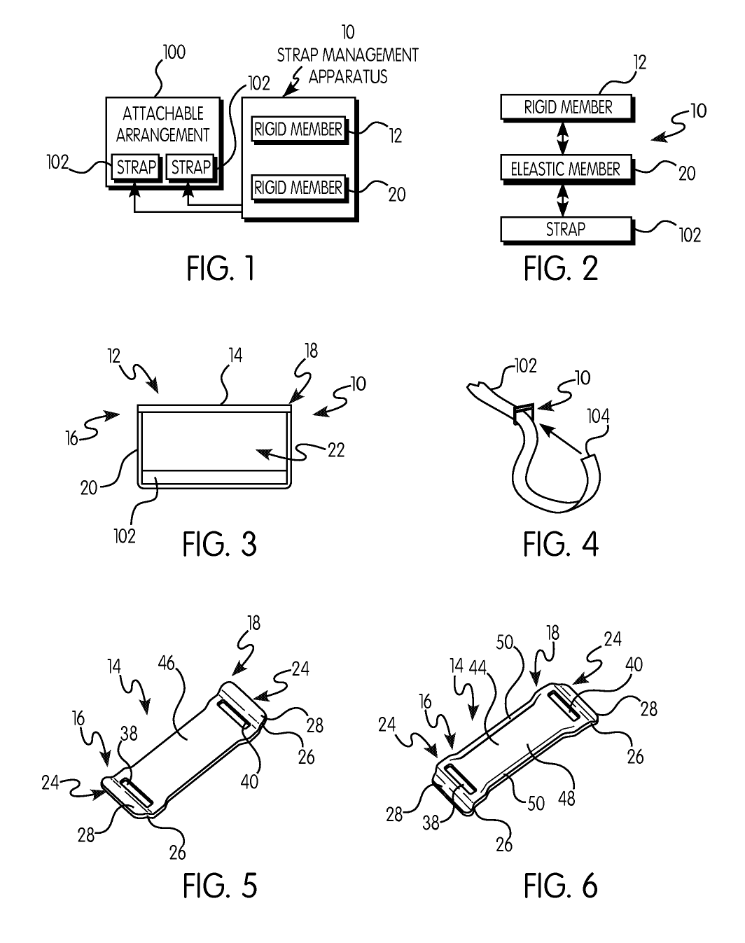

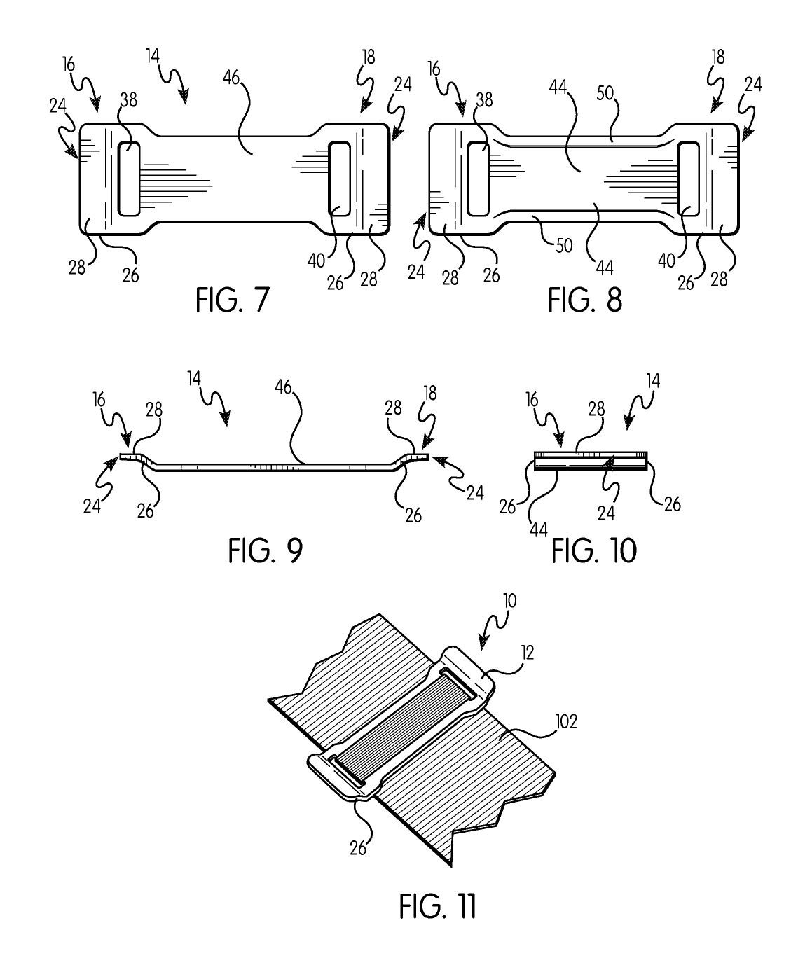

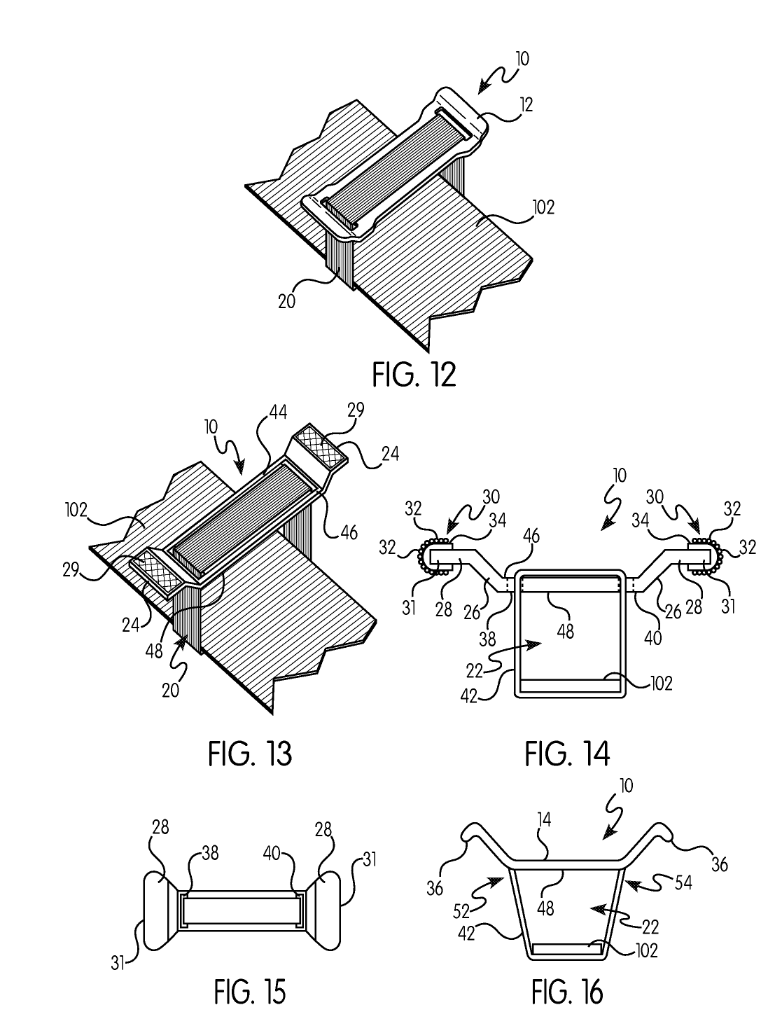

The present invention is directed to a strap management apparatus 10 for use in connection with an attachable arrangement 100, which includes at least one, and typically many, elongate straps 102 that include at least one free end 104. Various preferred and non-limiting embodiments of this strap management apparatus 10 are illustrated in FIGS. 1-17. The present invention is useful in connection with a variety of attachable arrangements 100, including, but not limited to harnesses, climbing harnesses, safety harnesses, fall protection arrangements, and safety belts.

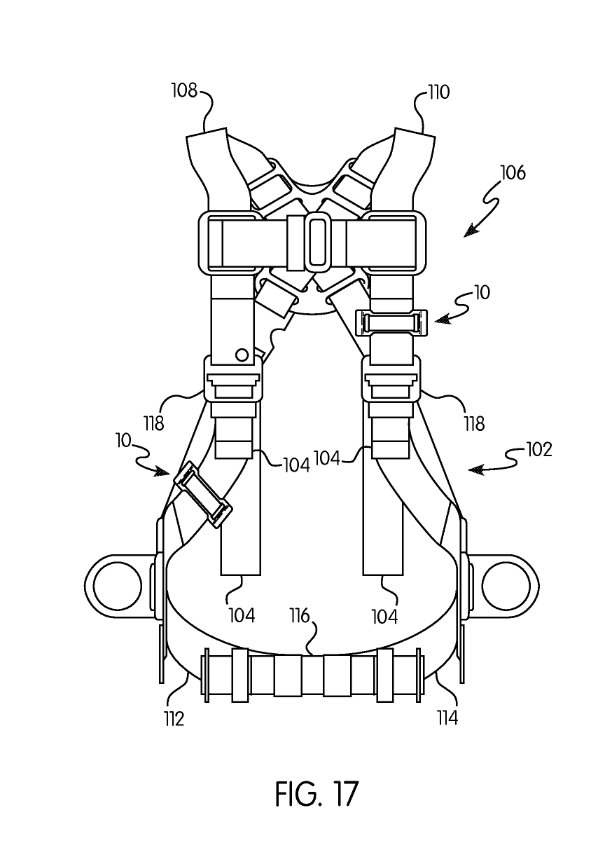

In addition, the presently-invented strap management apparatus 10 can be configured for use in connection with existing attachable arrangements 100, i.e., as a retrofit component or device, or installed and used during the manufacturing of the attachable arrangement 100, i.e., prior to sale or use by a distributor or consumer. While specifically discussed in connection with a full body harness having multiple straps 102, the strap management apparatus 10 of the present invention is useful in connection with any strap-based attachable arrangement 100 that has straps 102 with free ends 104 that dangle or otherwise remain loose when the attachable arrangement 100 is positioned on the user. Still further, the attachable arrangement 100 may use multiple strap management apparatuses 10 at various positions on or over the attachable arrangement 100 (e.g., FIG. 17).

As illustrated in schematic form in FIGS. 1 and 2, and in one preferred and non-limiting embodiment, the present invention provides a strap management apparatus 10 that includes a substantially rigid member 12 having a body 14 with a first end 16 and a second end 18. At least one substantially elastic member 20 is operatively engaged with the body 14 of the rigid member 12, as well as a portion of one or more straps 102 of the attachable arrangement 100. In particular, as shown in FIGS. 3 and 4, the substantially rigid member 12 is configured to be urged away from this portion of the strap 102, thereby creating an opening 22 through which the free end 104 of the strap 102 can be inserted. After insertion, the body 14 of the substantially rigid member 12 is released, and the elasticity of the elastic member 20 causes the opening 22 to shut and clamp or wedge a portion of the strap 102. In one preferred and non-limiting embodiment, this opening 22 is generally rectangular in shape, and in another preferred and non-limiting embodiment, this opening 22 is in the shape of a trapezoid. Further, and in this preferred and non-limiting embodiment, the portion or free end 104 of the strap 102 would be clamped or wedged between the body 14 of the rigid member 12 and the portion of the strap 102 (or some other strap 102) in the attachable arrangement 100. Such an arrangement in operation is illustrated in FIGS. 3 and 4.

In another preferred and non-limiting embodiment, the width of the body 14 of the rigid member 12 is substantially the same as or greater than the width of the strap 102 of the attachable arrangement 100. Similarly, the width of the opening 22 through which the free end 104 of the strap 102 can be inserted may be substantially the same as (e.g., the embodiment of FIG. 14) or greater than (e.g., the embodiment of FIG. 16) the width of the free end 104 of the strap 102. By having the width of the body 14 and/or at least a portion of the width of the resultant opening 22 with a greater width than the free end 104 of the strap 102, this free end 104 of the strap 102 is more easily inserted through the opening 22 without the need for manipulating, bending, or folding the strap 102. In addition, and as many users of an attachable arrangement 100 also use gloves or other coverings on their hands, it is beneficial to provide an appropriate and sufficient width to the body 14 and/or at least a portion of the opening 22 in order to prevent the need to manipulate the strap 102 to use the invention.

As illustrated in FIGS. 5-12 (in both a rest state and an operative state), and in another preferred and non-limiting embodiment, the body 14 of the rigid member 12 includes a tab 24. Preferably, this tab 24 is located on and extends from both the first end 16 of the body 14 and a second end 18 of the body 14. As best illustrated in FIGS. 5 and 6, this tab 24 may include an intermediate portion 26 and an end portion 28, where the end portion 28 of the tab 24 is spaced from the body 14 via the intermediate portion 26. In order to provide a more easily graspable tab 24, this tab 24, the intermediate portion 26 thereof, and/or the end portion 28 thereof may be coated, roughened, textured, contoured, shaped, and/or flexible. The body 14 of the rigid member 12 is preferably manufactured from at least one of the following materials: rubber, plastic, a synthetic material, metal, or any combination thereof.

In the preferred and non-limiting embodiment of FIGS. 5-12, the tab 24 includes a sloped intermediate portion 26 and an extending end portion 28. Such an arrangement and configuration allows the user to more easily grasp the rigid member 12 and urge it away from the strap 102 to which it is attached, to create the required opening 22. In addition, and as discussed above, the use of such tabs 24 also allow the user to manipulate the apparatus 10 while wearing gloves. Still further, this tab 24 may be manufactured from a variety of materials that may assist in the manipulation process in order to operate the strap management apparatus 10. For example, the tab 24, the intermediate portion 26 thereof, and/or the end portion 28 thereof may be manufactured from at least one of the following materials: rubber, plastic, a synthetic material, a flexible material, a coated material, a roughened material, a textured material, a contoured material, or any combination thereof.

As illustrated in the preferred and non-limiting embodiment of FIG. 13, the substantially rigid member 12 includes a tab 24 extending from the first end 16 of the body 14 and a tab 24 extending from the second end 18 of the body 14. Further, the end portion 28 includes a roughened and/or grooved outer surface 29 that allows for better friction contact between the user's fingers or gloved hand and the tabs 24 of the rigid member 12.

In another preferred and non-limiting embodiment, and as illustrated in FIG. 14, a tip 30 may be positioned over the end portion 28 of the tab 24. The use of such a tip 30 would allow for an even greater measure of manipulation and operation of the strap management apparatus 10. Of course, this tip 30 may be permanently positioned over a distal end 31 of the end portion 28 of the tab 24, or alternatively, removably positionable over the distal end 31 of the end portion 28 of the tab 24. In addition, and in this illustrated embodiment, the tip 30 includes grippable ribs 32 positioned over the outer surface 34 of the tip 30. The use of these ribs 32 disposed over the entire outer surface 34 (or a substantial portion thereof) of the tip 30 allows for more effective and efficient manipulation and operation.

Further, this tip 30 may be coated, roughened, textured, contoured, shaped, and/or flexible. In addition, and like the tab 24, the tip 30 may be manufactured from rubber, a synthetic material, a flexible material, a coated material, a roughened material, a textured material, and/or a contoured material. As seen in the embodiment of FIG. 15, the end portion 28 of the tab 24 is flared, and in the preferred and non-limiting embodiment of FIG. 16, the distal end 31 of the end portion 28 of the tab 24 is oriented at a different angle than the body 14, thereby creating a lip 36. By using the flared arrangement of FIG. 15 or a lip 36 on the end of the tab 24 in FIG. 16, additionally improved manipulation and operation of the strap management apparatus 10 is provided.

As illustrated in the preferred and non-limiting embodiments of FIGS. 5-15, the body 14 of the substantially rigid member 12 includes a first slot 38 extending through a portion of the first end 16 of the body 14 through which at least a portion of the elastic member 20 is positioned. Further, a second slot 40 extends through a portion of the second end 18 of the body 14 through which at least a portion of the substantially elastic member 20 is positioned. In this embodiment, the elastic member 20 is in the form of an elastic band 42 that extends through the first slot 38 and the second slot 40, as well as around a portion of the strap 102. In such an arrangement, it is the elastic band 42 that allows the strap management apparatus 10 to be attached to the strap 102, as well as providing for the creation of an opening 22 through which the free end 104 of the strap 102 can be inserted.

In another preferred and non-limiting embodiment, the body 14 of the rigid member 12 includes a groove 44 that extends at least partially across an upper surface 46 of the body 14. The elastic member 20 (or elastic band 42) extends along the groove 44, which acts as a seat for the band 42. See FIG. 13. As illustrated in FIGS. 5-12, it is further envisioned that the groove 44 can be positioned across at least a portion of the lower surface 48 of the body 14, such that one or more ribs 50 are created on either side of the groove 44. Such ribs 50 can be used to assist in contacting the free end 104 or portion of the strap 102 that is inserted through the opening 22. Such an arrangement will help retain the free end 104 or portion of the strap 102 after operation and insertion. Of course, the lower surface 48 of the body 14 may also include a coating, a roughened surface, texture, contour, shape, and/or flexibility, in order to assist or augment the clamping or wedging process, and in order to ensure that the free end 104 or the portion of the strap 102 that is inserted through the opening 22 does not become dislodged or loose.

In yet another preferred and non-limiting embodiment, and as illustrated in FIG. 16, the elastic member 20 may be in the form of the elastic band 42 with a first end 52 attached to the first end 16 of the body 14, specifically at the lower surface 48 thereof, and a second end 54 attached to the second end 18 of the body 14, again at the lower surface 48 thereof. In this embodiment, as with the previously-discussed embodiments, the elastic band 42 also extends around the strap 102, and in operation, creates the required opening 22, for insertion of the free end 104 of the strap 102. Still further, in this embodiment, the width of the body 14 of the rigid member 12 is greater than the width of the strap 102, thereby resulting in at least a portion of the resultant opening 22 being wider than the width of the strap 102. Again, this provides for easier insertion of the free end 104 of the strap 102 therethrough.

It is envisioned that the strap management apparatus 10 can be permanently attached to specific areas or positions along the straps 102, i.e., those positions that are in optimal areas for receiving and attaching the free ends 104 of some of the straps 102. However, in a preferred and non-limiting embodiment, the strap management apparatus 10 is adjustably slidable along the length of the strap 102. In particular, by using an elastic band 42 that extends around the strap 102 (but is not attached thereto), the strap management apparatus 10 can be moved along the strap 102 by urging the body 14 away from the strap 102 sufficiently to allow for this sliding adjustment.

As discussed above, the presently-invented strap management apparatus 10 may be used in connection with an existing attachable arrangement 100, or installed during the manufacturing and assembly process. For example, in one preferred and non-limiting embodiment, and as illustrated in FIG. 17, multiple strap management apparatuses 10 are provided on a full body harness 106. This harness 106 preferably includes two shoulder straps 108, 110 (preferably mirror images of each other), two leg straps 112, 114 (preferably identical), and a sub-pelvic strap 116. Each shoulder strap 108, 110 is attached at one end to an adjustment mechanism 118, and preferably, such attachment is a permanent connection made by passing an end of a shoulder strap 108, 110 through a slot in the adjustment mechanism 118, and sewing the end to the shoulder strap 108, 110 to form a closed loop. The leg strap 112, 114 is attached at one point to the shoulder strap 108, 110, and again, preferably, such attachment is a permanent connection made by sewing.

As seen in the embodiment of FIG. 17, multiple free ends 104 exist, and it is these free ends 104 that, after positioning and adjusting the harness 106 on the user's body, are left dangling or free. Further, it is these free ends 104 that may cause various safety issues and become lodged or caught on equipment resulting in an unsafe condition. Accordingly, after attachment and adjustment of the attachable arrangement 100 on the user, these free ends 104 can be used in connection with one or more of the strap management apparatus 10 that are positioned at various and adjustable places along the straps 102.

In this manner, the present invention provides a strap management apparatus 10 that is useful in connection with new and existing attachable arrangements 100. Further, the present invention provides a strap management apparatus 10 and arrangement 100 that can be adjustable, easy to manipulate in the field, and holds the free ends 104 of the straps 102 in a safe position with respect to the user.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A strap management apparatus for an attachable arrangement including at least one elongate strap having at least one free end, the strap management apparatus comprising:
a substantially rigid member having a body with a first end and a second end; and
at least one substantially elastic member operatively engaging the body of the substantially rigid member and a portion of the at least one strap of the attachable arrangement;
wherein the substantially rigid member is configured to be urged away from the portion of the at least one strap, thereby creating an opening through which the at least one free end of the at least one strap can be inserted.

2. The strap management apparatus of claim 1, wherein the width of the body of the substantially rigid member is at least substantially the same as the width of the at least one strap.

3. The strap management apparatus of claim 1, wherein the width of at least a portion of the opening through which the at least one free end of the at least one strap can be inserted is substantially the same as or greater than the width of the at least one free end of the at least one strap.

4. The strap management apparatus of claim 3, further comprising at least one tab extending from at least one of the first end and the second end of the body of the rigid member.

5. The strap management apparatus of claim 4, wherein the at least one tab includes an intermediate portion and an end portion, wherein the end portion of the at least one tab is spaced from the body via the intermediate portion.

6. The strap management apparatus of claim 4, wherein at least a portion of the at least one tab is at least one of the following: coated, roughened, textured, contoured, shaped, flexible, or any combination thereof.

7. The strap management apparatus of claim 4, wherein at least a portion of the at least one tab is manufactured from at least one of the following: rubber, a synthetic material, a flexible material, a coated material, a roughened material, a textured material, a contoured material, or any combination thereof.

8. The strap management apparatus of claim 4, further comprising at least one tip that is positioned over a distal portion of the end portion of the at least one tab.

9. The strap management apparatus of claim 8, wherein at least a portion of the at least one tip is at least one of the following: coated, roughened, textured, contoured, shaped, flexible or any combination thereof.

10. The strap management apparatus of claim 8, wherein the at least a portion of the at least one tip is manufactured from at least one of the following: rubber, a synthetic material, a flexible material, a coated material, a roughened material, a textured material, a contoured material, or any combination thereof.

11. The strap management apparatus of claim 8, wherein the at least one tip is removably positionable over the distal portion of the end portion of the at least one tab.

12. The strap management apparatus of claim 4, wherein a distal portion of the end portion of the at least one tab is flared on at least one side thereof.

13. The strap management apparatus of claim 1, wherein at least a portion of the body of the substantially rigid member is manufactured from at least one of the following: rubber, plastic, a synthetic material, metal, or any combination thereof.

14. The strap management apparatus of claim 1, wherein the body of the substantially rigid member further comprises:
a first slot extending through a portion of the first end of the body through which at least a portion of the substantially elastic member is positioned; and
a second slot extending through a portion of the second end of the body through which at least a portion of the substantially elastic member is positioned;
wherein the substantially elastic member comprises an elastic band extending through the first slot and the second slot, and around at least a portion of the at least one strap.

15. The strap management apparatus of claim 1, wherein the body of the substantially rigid member further comprises a groove extending at least partially across an upper surface of the body, wherein the substantially elastic member comprises an elastic band extending along the groove and around at least a portion of the at least one strap.

16. The strap management apparatus of claim 1, wherein the substantially elastic member comprises an elastic band with a first end attached to the first end of the body of the substantially rigid member and a second end attached to the second end of the body of the substantially rigid member, and extending around at least a portion of the strap.

17. The strap management apparatus of claim 1, wherein the apparatus is adjustably slidable along the length of the at least one strap.

18. The strap management apparatus of claim 1, wherein the attachable arrangement is at least one of a harness, a full body harness, a climbing harness, a safety harness, a fall protection arrangement, and a safety belt.

19. An attachable arrangement, comprising:
at least one elongate strap having at least one free end; and
at least one strap management apparatus, including:
(i) a substantially rigid member having a body with a first end and a second end; and
(ii) at least one substantially elastic member operatively engaging the body of the rigid member and a portion of the at least one strap of the attachable arrangement;
wherein the rigid member is configured to be urged away from the portion of the at least one strap, thereby creating an opening through which the at least one free end of the at least one strap can be inserted.

20. An attachable arrangement configured for removable attachment to a person, the attachable arrangement comprising:
a plurality of elongate attachment straps, wherein at least one of the plurality of attachment straps includes at least one free end; and
at least one strap management apparatus, including:
(i) a substantially rigid member having a body with a first end and a second end; and
(ii) at least one substantially elastic member operatively engaging the body of the rigid member and a portion of at least one of the plurality of straps of the attachable arrangement;
wherein the rigid member is configured to be urged away from the portion of the at least one of the plurality of straps, thereby creating an opening through which the at least one free end of the at least one of the plurality of straps can be inserted.
